(19) United States
(12) Patent Application Publication
(10) Pub. No.: US 2017/0153089 A1
(43) Pub. Date: Jun. 1, 2017

(54) LIGHTWEIGHT BODY ARMOR

(71) Applicants: Joel Bishara Bahu, Ben Lomond, CA (US); Mike Berritto, III, Felton, CA (US)

(72) Inventors: Joel Bishara Bahu, Ben Lomond, CA (US); Mike Berritto, III, Felton, CA (US)

(21) Appl. No.: 15/236,587

(22) Filed: Aug. 15, 2016

Related U.S. Application Data
(60) Provisional application No. 62/204,772, filed on Aug. 13, 2015.

(51) Int. Cl. F41H 5/04; B32B 27/06; B32B 15/04; B32B 3/08; B32B 27/32; B32B 5/18

(52) U.S. Cl. CPC F41H 5/0464; B32B 27/32; B32B 5/18; B32B 15/046; B32B 3/08; B32B 27/065; B32B 2571/02; B32B 2305/022

(57) ABSTRACT

Body armor is provided. The body armor includes a ballistic material layer having a front surface and a rear surface. A foam layer is adhered to the front surface. A metal plate is adhered to the foam layer, thereby sandwiching the foam layer in between the ballistic material layer and the metal plate. If a bullet striking the body armor passes through the metal plate, the bullet is redirected by the metal plate by creating asymmetrical loads tending to rotate the projectile perpendicular to its path. The projectile is allowed to skew in the gap formed by the foam layer and enters the ballistic material layer at an angle, which allows the multiple layers of fabric in the ballistic material layer to absorb the energy, preventing full penetration of the body armor.

### CROSS-REFERENCE TO RELATED APPLICATION

This application claims the benefit of priority of U.S. provisional application No. 62/204,772, filed Aug. 13, 2015, the contents of which are herein incorporated by reference.

### BACKGROUND OF THE INVENTION

The present invention relates to body armor and, more particularly, to lightweight and effective body armor.

Body armor offered today in the market place is heavy, and as a result when worn for extended periods of time, encumbers the activities of the user. The current body armor used is ceramic based plates, which are heavy. These body armor products are intended to be used by individuals in dangerous and high stress situations during planned or unexpected high tension encounters. Current body armor weighs around 8 lbs and causes fatigue to a user. Further, ceramic plates are consistently unreliable as they are proven to fail multi-hit firings that will cause injuries and fatalities under any condition. Weight, ballistic integrity and cost all contribute to the challenges of creating an optimal design configuration that protects life and prevents injury.

As can be seen, there is a need for an improved lightweight body armor that effectively stops high velocity rounds fired in a close pattern.

### SUMMARY OF THE INVENTION

In one aspect of the present invention, a body armor comprises: a ballistic material layer; a foam layer; and a metal plate, wherein the foam layer is disposed in between the ballistic material layer and the metal plate.

In another aspect of the present invention, a body armor comprises: an ultra-high-molecular-weight polyethylene compressed unidirectional fabric board resin; a hardened armor steel plate; and a double sided acrylic foam tape comprising a first side adhered to the ultra-high-molecular-weight polyethylene compressed unidirectional fabric board resin and a second side adhered to the hardened armor steel plate.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective view of an embodiment of the present invention;

FIG. 3 is a section detail view of the present invention taken along line 3-3 in FIG. 1;

FIG. 4 is a section detail view of the present invention taken along line 4-4 in FIG. 2; and

FIG. 5 is a front perspective view of the present invention illustrated without the self-catalyzing polyurethane coating to demonstrate the configuration of the aluminum foil tape.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a lightweight tactical armor plate. The present invention withstands multiple hits in a small area, which is an important feature to protect against automatic and semi-automatic weapons such as an AK 47 and AR 15. The present invention is capable of withstanding, with no loss of ballistic capability, multiple strikes in a very close pattern within a 2″ radius without failure. The plate design weighs around six pounds, is thinner and very capable of protecting the user against multiple hits in a close pattern.

The present invention includes advanced material selection, unique construction and assembly techniques which allows the manufacture of a lightweight ballistic body armor plate capable of resisting multiple ballistic threats that exceeds certified federal ballistic standards. The order of layering and thickness of each layer has a unique and unprecedented effect on the ballistic characteristics of the body armor. The result is a lighter-weight and higher performance body armor.

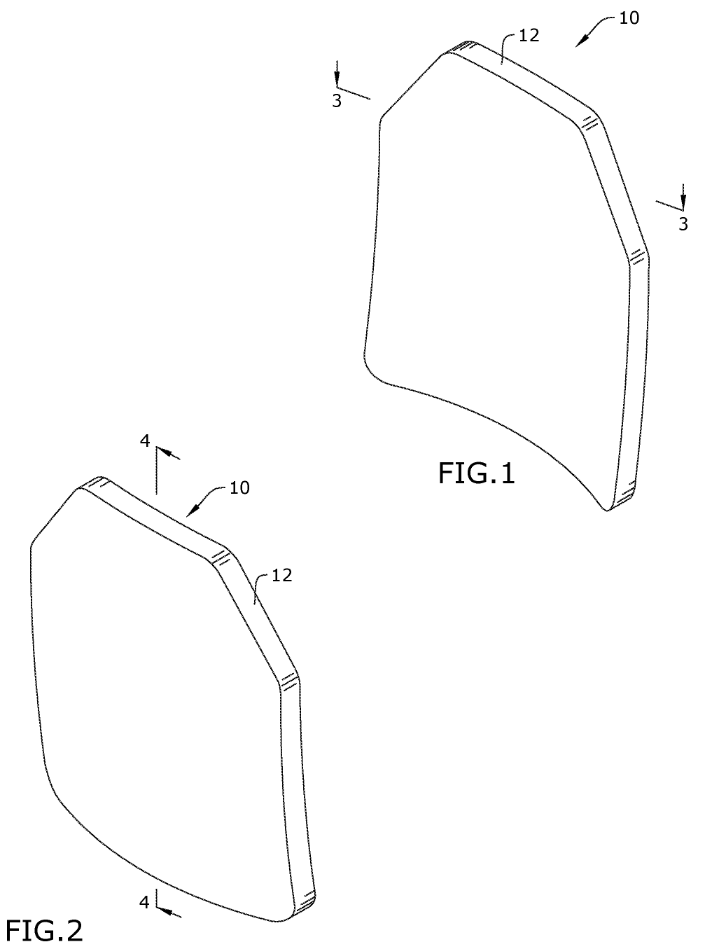

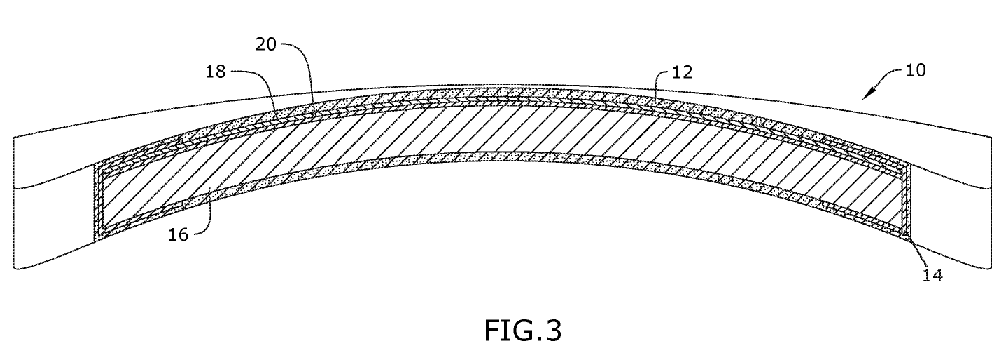

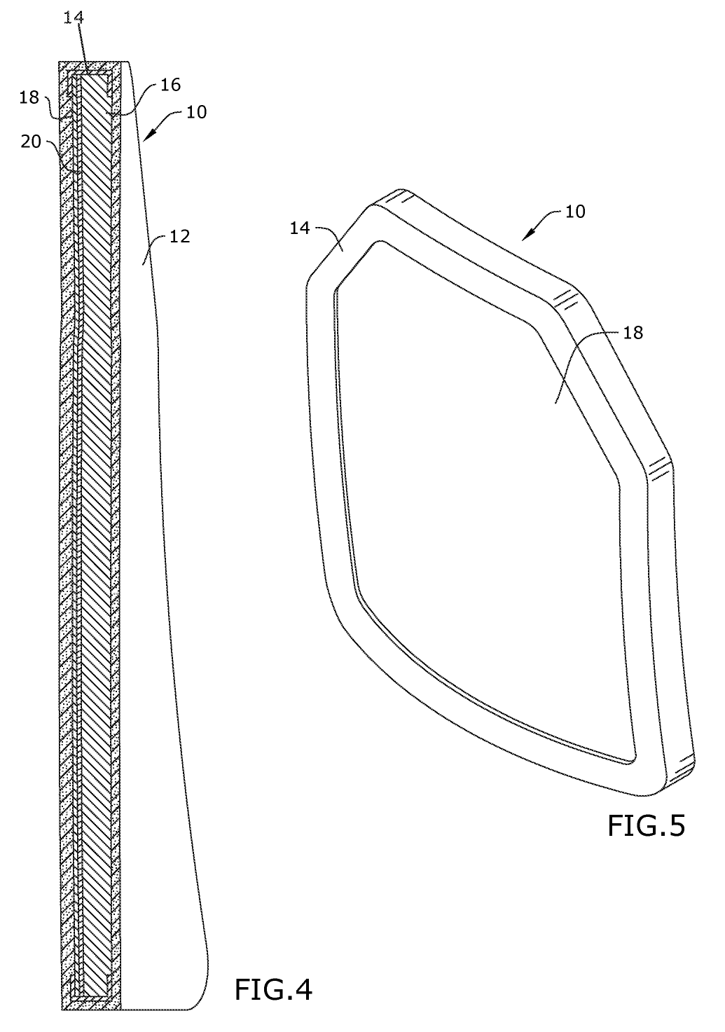

Referring to FIGS. 1 though 5, the present invention includes body armor 10. The body armor 10 includes a ballistic material layer 16 having a front surface and a rear surface. A foam layer 20 is adhered to the front surface. A metal plate 18 is adhered to the foam layer 20, thereby sandwiching the foam layer 20 in between the ballistic material layer 16 and the metal plate 18. If a bullet striking the body armor 10 passes through the metal plate 18, the bullet is redirected by the metal plate 18 by creating asymmetrical loads tending to rotate the projectile perpendicular to its path. The projectile is allowed to skew in the gap formed by the foam layer 20 and enters the ballistic material layer 16 at an angle, which allows the multiple layers of fabric in the ballistic material layer 16 to absorb the energy, preventing full penetration of the body armor 10.

The ballistic material layer 16 of the present invention may be a polyethylene, a ballistic fiberglass, an aluminum foam, a liquid, such as a shear thickening fluid or a magnetorheological fluid, or a combination thereof. The polyethylene may be an ultra-high-molecular-weight polyethylene UHMWPE compressed unidirectional fabric board resin. The present invention may utilize about 50 layers up to about 68 layers, such as about 62 layers, of the ballistic material layer 16. For example, the present invention may include 62 layers of the ultra-high-molecular-weight polyethylene UHMWPE compressed unidirectional fabric board resin.

The metal plate 18 of the present invention may be a mild steel, hardened steel, aluminum, aluminum foam composite, or the like. For example, the metal plate 18 may be a hardened armor steel plate. The metal plate 18 may include a thickness of about 2 mm up to about 3 mm, such as about 2.5 mm. For example, the present invention may include a hardened armor steel plate with a thickness of about 2.5 mm.

The foam layer 20 of the present invention may include an open or closed cell foam. In certain embodiments, the foam layer 20 may be a viscoelastic polyurethane foam, an acrylic foam double sided tape, or the like. In such embodiments, the foam layer 20 is adhered to the metal plate 18 and the ballistic material layer 16. For example, the double sided acrylic foam tape may include a first side adhered to the ultra-high-molecular-weight polyethylene compressed unidirectional fabric board resin and a second side adhered to the hardened armor steel plate. The foam layer 20 may include a thickness of about 0.03125 inches up to about 0.250 inches such as about 0.0625 inches.

In certain embodiments, the present invention may include UHMWPE compressed unidirectional tape, an aluminum foil tape 14 or other reinforced tape. The aluminum foil tape 14 may wrap around the edges of the ballistic material layer 16, the foam layer 20 and the metal plate 18. For example, the aluminum foil tape 14 may wrap around the edges of the ultra-high-molecular-weight polyethylene compressed unidirectional fabric board resin, the double sided acrylic foam tape and the hardened armor steel plate. The aluminum foil tape 14 provides for smooth edges and may protect the ballistic material layer 16 from damage.

The present invention may further include an outer coating 12. The outer coating 12 may include a self catalyzing polyurethane coating, a sealed nylon bag or a rubberized coating. The outer coating 12 may surround the body armor 10. For example, the outer coating 12 may cover a front surface of the hardened armor steel plate, the aluminum foil tape and a rear surface of the ultra-high-molecular-weight polyethylene compressed unidirectional fabric board resin. The outer coating 12 prevents the layers of the ballistic material layer 16 from separating and protects the edges of the body armor 10.

The metal plate 18 is placed at the front, or “strike face” of the body armor 10. The foam layer 20 or double sided foam tape contributes by creating a space in between the metal plate 18 and the ballistic material layer 16. After the bullet passes through the metal plate 18, the space allows the bullet to enter the backing of ballistic material layer 16 at a slight angle so kinetic energy contained in the round is lost to the armor and the round is captured by the ballistic material layer 16.

An exemplary method of making the present invention may include the following. The steel and UHMWPE Compressed Unidirectional Fabric Board is cut to the correct profile using a waterjet cutting machine. A large piece of acrylic foam double backed tape, large enough to cover the piece completely, is adhered to the steel plate by removing one side of the backing from the tape and pressing into the surface of the fully cleaned, lightly abraded (150 grit) steel plate. The fully primed (Scotch Brand #94 TM primer), on one side facing the steel, piece of UHMWPE is then aligned exactly with and pressed into the other side of the double back tape after the backing material is removed. The assembly is then placed in a light (30 lb) press for seventy two (72) hours to facilitate complete microscopic adhesion to both surfaces. After the pressing period, the assembly is wrapped around the entire perimeter with foil tape to reduce the effect of secondary spalling during impact. At this point the entire assembly is coated with the self catalyzing polyurethane coating.

It should be understood, of course, that the foregoing relates to exemplary embodiments of the invention and that modifications may be made without departing from the spirit and scope of the invention as set forth in the following claims.

What is claimed is:

1. A body armor comprising:
a ballistic material layer;
a foam layer; and
a metal plate, wherein
the foam layer is disposed in between the ballistic material layer and the metal plate.

2. The body armor of claim 1, wherein the ballistic material layer is a polyethylene.

3. The body armor of claim 2, wherein the polyethylene is an ultra-high-molecular-weight polyethylene compressed unidirectional fabric board resin.

4. The body armor of claim 1, wherein the metal plate is a hardened armor steel plate.

5. The body armor of claim 1, wherein the foam layer is a double sided acrylic foam tape comprising a first side adhered to the ballistic material layer and a second side adhered to the metal plate.

6. The body armor of claim 1, further comprising an aluminum foil tape covering edges of the ballistic material layer, the foam layer and the metal plate.

7. The body armor of claim 6, further comprising an outer layer covering a front surface of the metal plate, the aluminum foil tape and a rear surface of the ballistic material layer.

8. The body armor of claim 7, wherein the outer layer comprises a self catalyzing polyurethane coating.

9. A body armor comprising:
an ultra-high-molecular-weight polyethylene compressed unidirectional fabric board resin;
a hardened armor steel plate; and
a double sided acrylic foam tape comprising a first side adhered to the ultra-high-molecular-weight polyethylene compressed unidirectional fabric board resin and a second side adhered to the hardened armor steel plate.

10. The body armor of claim 9, further comprising an aluminum foil tape covering an edge of the ultra-high-molecular-weight polyethylene compressed unidirectional fabric board resin, the double sided acrylic foam tape and the hardened armor steel plate.

11. The body armor of claim 10, further comprising an outer layer covering a front surface of the hardened armor steel plate, the aluminum foil tape and a rear surface of the ultra-high-molecular-weight polyethylene compressed unidirectional fabric board resin.

12. The body armor of claim 11, wherein the outer layer comprises a self catalyzing polyurethane coating.
